(19) United States
(12) Patent Application Publication
(10) Pub. No.: US 2021/0190128 A1
(43) Pub. Date: Jun. 24, 2021

(54) SAFETY DEVICE

(71) Applicant: "Height Technology Development" Ltd., Pleven (BG)

(72) Inventors: Viktoriya Plamenova Zhekova, Pleven (BG); Natalia llieva Manolova, Pleven (BG)

(21) Appl. No.: 17/053,651

(22) PCT Filed: May 10, 2018
(86) PCT No.: PCT/BG2018/000019

§ 371 Date: Nov. 6, 2020

(51) Int. Cl. F16B 41/00; F16B 37/14

(52) U.S. Cl. CPC F16B 41/005; F16B 37/14

(57) ABSTRACT

The present invention concerns a safety device designed to cover an element or a hole which needs to be placed in a safe condition, wherein the safety device comprises a coded body, a safety cover, a first locking element and a second locking element positioned between the coded body and the safety cover, wherein the coded body comprises a first contact surface and a second contact surface, wherein the first locking element comprises a first abutting element configured in such a way that it abuts the first contact surface, wherein the second locking element comprises a second abutting element configured in such a way that it abuts the second contact surface, and wherein the first contact surface is not coplanar with the second contact surface.

### TECHNICAL FIELD OF THE INVENTION

The present invention concerns a safety device designed to cover an element or a hole which needs to be placed in a safe condition. More specifically, the present invention concerns a safety device which makes it possible to cover an element or a hole that needs to be placed in a safe condition with a safety cover that can be removed by moving it according to a predetermined combination.

### STATE OF THE ART

In different fields of application it is often necessary to cover elements which need to be placed in a safe condition, in such a way that they can be accessed exclusively by authorized operators/users.

By way of example, an element which needs to be placed in a safe condition may be a locking bolt or nut of a car or motorbike wheel rim. As an alternative, the element which needs to be placed in a safe condition may be the filler cap of a car or a motorbike. As another alternative, the element which needs to be placed in a safe condition may be a bolt, a nut, a button of a device. As another alternative, the element which needs to be placed in a safe condition may be a hole or a cavity such as, for example, the hole of the filler cap of a car or a motorbike, or an electric outlet, etc. More generally, the element which needs to be placed in a safe condition may be any element that must not be rotated, pushed, removed, accessed, etc. by unauthorized operators/users.

The invention allows such an element to be placed in a safe condition by means of a safety device that, through a safety cover, covers the element in such a way as to prevent access to the latter unless the safety cover is removed. The removal of the safety cover requires that the latter be moved according to a predetermined combination and thus allows said element to be accessed exclusively by the staff who knows the combination.

An embodiment of the invention may refer to a safety device designed to cover an element or a hole which needs to be placed in a safe condition, wherein the safety device comprises: a coded body, a safety cover, a first locking element and a second locking element positioned between the coded body and the safety cover, wherein the coded body comprises a first contact surface and a second contact surface, wherein the first locking element comprises a first abutting element configured in such a way that it abuts the first contact surface, wherein the second locking element comprises a second abutting element configured in such a way that it abuts the second contact surface, and wherein the first contact surface is not coplanar with the second contact 20 surface.

In some embodiments, the coded body may comprise a third contact surface and a fourth contact surface, wherein the third contact surface may not be coplanar with the fourth contact surface.

In some embodiments, the first abutting element may be longer than the second abutting element.

In some embodiments, the coded body may comprise a coding cavity inside which the first abutting element and the second abutting element can be at least partially positioned.

In some embodiments, the coding cavity can be included between the first contact surface and the third contact surface and between the second contact surface and the fourth contact surface.

In some embodiments, the coded body may comprise a release cavity connected with the coding cavity, through which the first abutting element and/or the second abutting element can pass.

In some embodiments, the safety cover may be provided with grooves.

In some embodiments, the distance between the first contact surface and the release cavity, and/or the distance between the second contact surface and the release cavity may depend on the position of the grooves, and may be preferably equal to the angular dimension of, a plurality of grooves, even more preferably equal to a multiple of the angular dimension of one of the grooves.

In some embodiments, the safety cover may comprise a first seat for the first locking element and a second seat for the second locking element. In some embodiments, the first locking element may comprise a first body, the first body may describe a first plane, wherein the first abutting element may be inclined with respect to the first plane.

In some embodiments, the coded body may comprise a first abutting ring and a second abutting ring, wherein the first abutting ring may comprise the first contact surface, wherein the second abutting ring may comprise the second contact surface, wherein the first abutting ring and the second abutting ring can be movable with respect to each other in a coding position of the coded body and can be fixed with respect to each other in a locking position of the coded body.

In some embodiments, the coded body may comprise a plurality of locking rings among which there are the first abutting ring and the second abutting ring, wherein the coded body may comprise a supporting element on which the first abutting ring, the second abutting ring and the plurality of locking rings are assembled.

A further embodiment of the invention may refer to a safety device designed to cover an element or a hole which needs to be placed in a safe condition, wherein the safety device comprises: a safety cover, a first locking element and a second locking element positioned between the safety cover and the element or hole to be placed in a safe condition, wherein the safety cover comprises a first contact surface and a second contact surface, wherein the first locking element comprises a first abutting element configured in such a way that it abuts the first contact surface, wherein the second locking element comprises a second abutting element configured in such a way that it abuts the second contact surface, and wherein the first contact surface is not coplanar with the second contact 20 surface.

In some embodiments, the safety device may comprise: at least one first sealing ring and a second sealing ring, wherein the first sealing ring may comprise an oblique surface, and wherein the second sealing ring may comprise a surface that is at least partially complementary with the shape of the abutting element.

In some embodiments, the safety device may comprise: a thrust ring suited to thrust the first sealing ring and the second sealing ring. In some embodiments, the safety device may comprise: at least one first sealing ring and a second sealing ring, at least one first thrust element, wherein the first thrust element is configured to thrust the second sealing ring towards the first sealing ring.

### BRIEF LIST OF THE DRAWINGS

Further characteristics and advantages of the invention will be highlighted through the analysis of the following detailed description of some preferred but not exclusive embodiments, which are illustrated by way of indicative and not limiting example with the support of the attached drawings. In the drawings, the same reference numbers identify the same components.

In particular:

FIGS. 1A to 1G schematically show a safety device 1000 according to an embodiment of the invention;

FIG. 2 schematically shows a method of use of the safety device 1000;

FIGS. 3 to 5 schematically show safety devices 3000, 4000, 5000 according to alternative embodiments of the invention;

FIGS. 6, 6A, 7 and 8 schematically show locking elements 6200, 7200, 8200 and a safety device 6000 according to alternative embodiments of the invention;

FIGS. 9A to 9D schematically show a coded body 9100 according to an alternative embodiment of the invention;

Figure schematically shows a method of use of the coded body 9100;

FIGS. 11, 12, 13, 14A and 14B schematically show safety devices 11000, 12000, 13000, 14000 according to alternative embodiments of the invention;

FIG. 15 schematically shows a safety device 15000 according to an alternative embodiment of the invention and the respective method of use;

FIG. 16 schematically shows locking elements according to alternative embodiments of the invention;

FIGS. 17A and 17B schematically show a safety device 17000 according to an alternative embodiment of the invention;

FIG. 18 schematically shows a safety device 18000 according to an alternative embodiment of the invention.

### DETAILED DESCRIPTION OF THE INVENTION

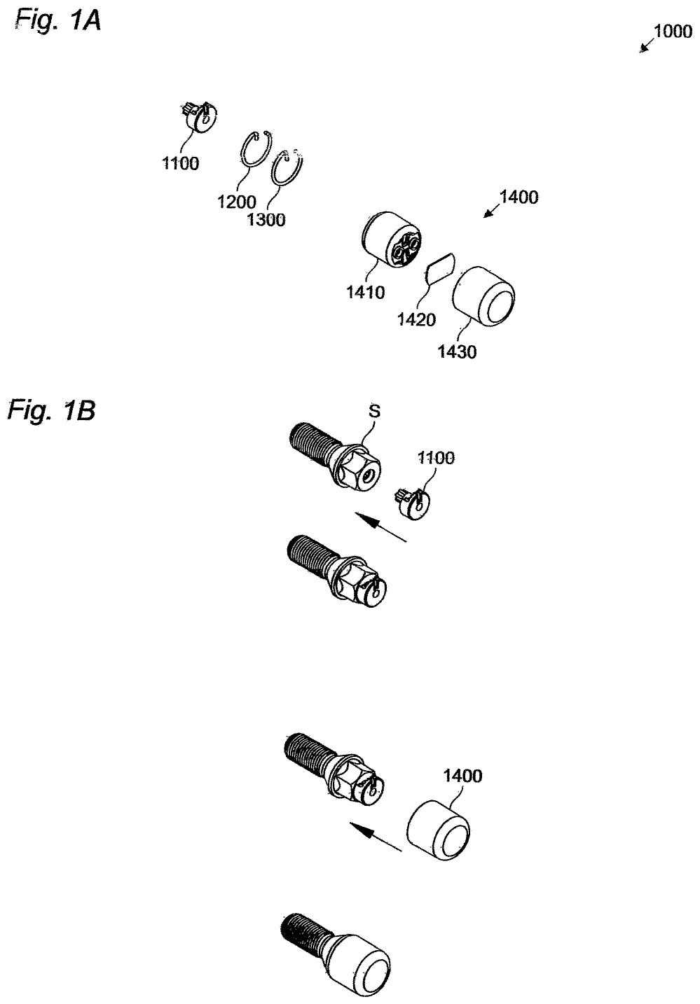

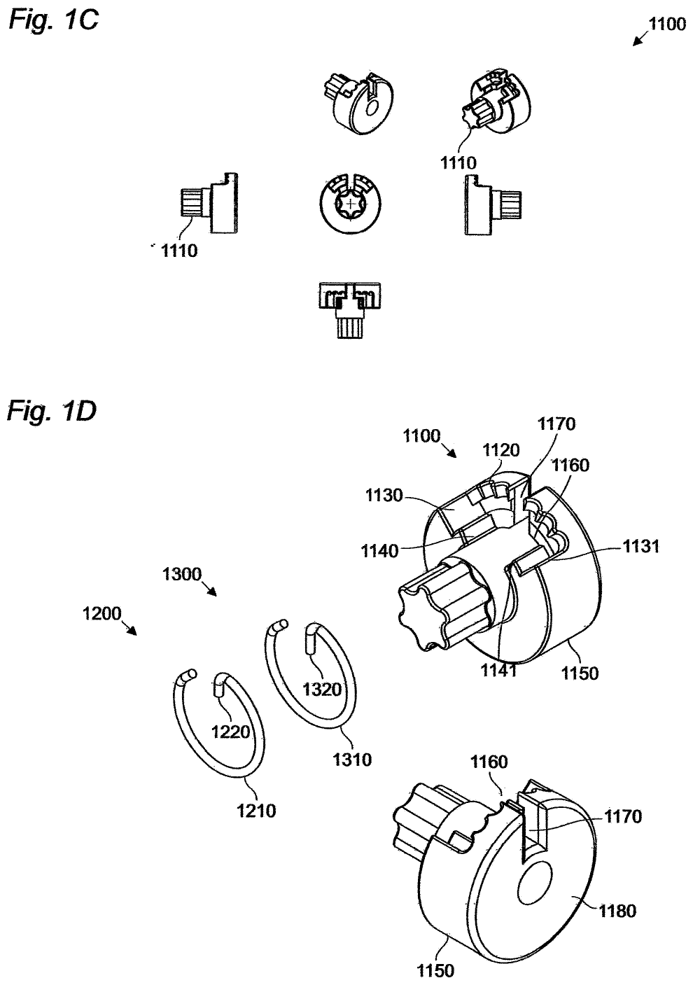

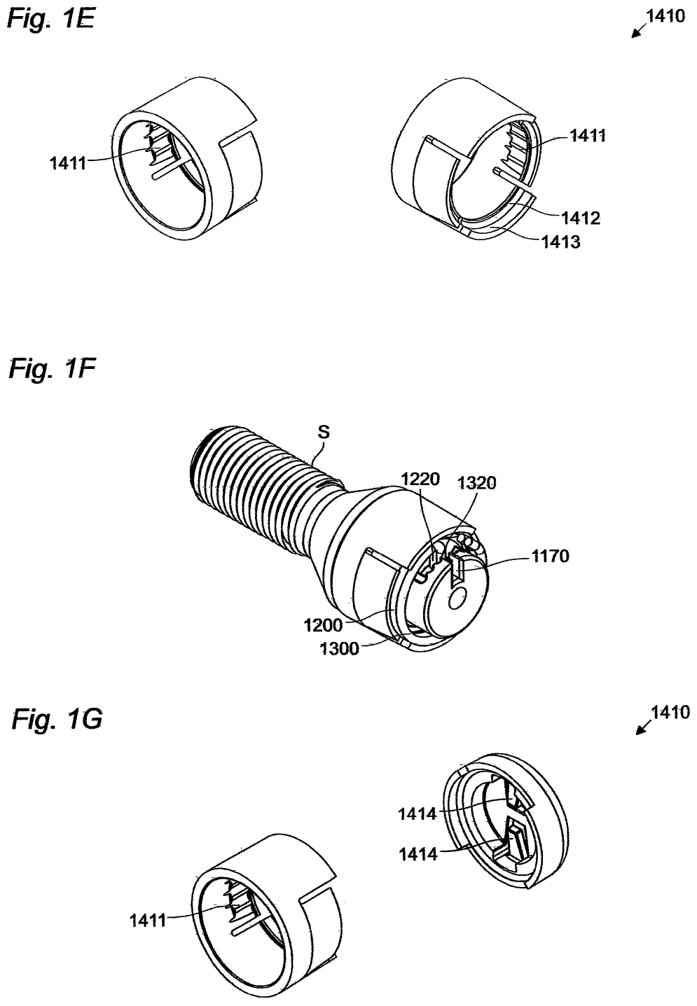

FIGS. 1A to 1G schematically illustrate an embodiment of the invention. FIG. 1A schematically shows an exploded view of the safety device 1000, while FIG. 1B schematically shows the application of a safety device 1000 to an element S which needs to be placed in a safe condition. In the case illustrated in FIG. 1B, the element S to be placed in a safe condition is a bolt. However, the present invention should not be considered limited to this type of elements to be placed in a safe condition but, for example, it can be used to place in a safe condition any element that must not be rotated, pressed, removed or accessed.

As can be seen in FIG. 1A, the safety device 1000 comprises a coded body 1100, a safety cover 1400 and one or more locking elements 1200, 1300. In the embodiment illustrated in FIG. 1A, the number of locking elements is two; however, according to the following description, it is clear that a different number of locking elements can be used. Generically, the locking elements 1200, 1300 are configured in such a way as to allow the safety cover 1400 to be removed from the coded body 1100 through a simple movement of the safety cover 1400 according to a predetermined combination.

In the embodiment illustrated herein, the safety cover 1400 comprises an inner cover 1410, an anti-perforation element 1420 and an outer cover 1430. However, it can be understood that the safety cover 1400 can be made as a single element, as clearly explained in the following description. The inner cover 1410 will be described in greater detail in the remaining part of the description in order to illustrate the characteristics which make it possible to lock and release the safety device 1100.

The anti-perforation element 1420 has the function to prevent the perforation of the safety cover 1400 by staff who is not authorized to remove it. Thus, the anti-perforation element 1420, for example, may be a special plate made of an anti-perforation metal. It will therefore be clear that the anti-perforation element 1420 is to be considered as an optional, since embodiments will be possible in which resistance to perforation may 20 be considered unnecessary, or embodiments will be possible in which the inner cover 1410 and/or the outer cover 1430 are made of an anti-perforation metal.

The outer cover 1430 has a similar function of protecting the inner cover 1410, in addition to facilitating the production of the device, since it makes it possible to use different materials and/or moulds for the inner cover 1410 and for the outer cover 1430. However, as in the case of the anti-perforation element 1420, the outer cover 1430 is to be considered as an optional and it will be possible to provide an embodiment in which the function of the outer cover 1430 is served by the inner cover 1410.

The locking element 1200 and the locking element 1300 are positioned between the coded body 1100 and the safety cover 1400. Specifically, in the embodiment illustrated herein, they are positioned between the coded body 1100 and the inner cover 1410. Even more specifically, in the embodiment illustrated herein and as better clarified in the description below, they are previously inserted in the inner cover 1410, inside respective seats, so that when the safety cover 1400 is placed on the coded body 1100 they come to be positioned between the two elements.

For this purpose, in the embodiment illustrated herein, the locking elements 1200, 1300 have a substantially circular shape and/or a shape that allows their elastic compression. More specifically, in the embodiment illustrated herein, the locking elements 1200, 1300 are snap rings, which means that they behave elastically, as is known. Specifically, they can be compressed, inserted in their respective seats and released, so that the elastic thrusting action they exert on the safety cover 1400 maintains them in position with respect to the safety cover 1400. Specifically, their insertion in their respective seats prevents them from moving in the longitudinal direction of extension of the cavity of the safety cover 1400. On the contrary, even though they are pressed against the safety cover 1400, they can rotate with respect to the latter, as described here below, following the application of sufficient force. As can be seen in FIG. 1B, the application of the safety device 1000 to the element to be placed in a safe condition S is obtained through a first application of the coded body 1100 to the element to be placed in a safe condition S, followed by the application of the safety cover 1400, inside which the locking elements 1200 and 1300 were previously positioned, to the coded body 1100. Specifically, in the embodiment illustrated herein, as can be seen in FIG. 1C which shows several views of the coded body 1100, the coded body 1100 comprises a fixing element 1110 whose shape allows it to be restrained in the element to be placed in safety condition S. In the embodiment illustrated herein, the fixing element 1110 is constituted by a plurality of small blades which are compressed by inserting them in a corresponding hole provided in the element to be placed in a safe condition S, in such a way as to ensure the union between the coded body 1100 and the element to be placed in a safe condition S. It will be clear, however, that different embodiments of the fixing element 1110 are possible. For example, it will be possible to make the fixing element 1110 with a different shape, which however should make it possible to join the coded body 1100 to the element to be placed in a safe condition S in such a way that they are substantially integral with each other. In alternative embodiments, it will also be possible to glue or weld the safety device 1000 onto the element to be placed in a safe condition S, so that the fixing element 1110 consists of glue, a weld or similar systems. In some embodiments, the component 1100 and the component S, instead of being joined to each other, can be replaced by a single piece constituted, for example, by a mould.

As shown in FIG. 1D, the coded body 1100 is provided with a contact surface 1130 and a contact surface 1140. In the embodiment illustrated herein, the contact surface 1130, as well as the contact surface 1140, extends in a substantially radial direction with respect to the longitudinal axis of extension of the coded body 1100. This embodiment, however, is not necessary. In fact, it will be sufficient for the contact surface 1130 and/or the contact surface 1140 to have such a shape that they can lock the movement of the locking elements 1200, 1300, as is clear from the following description.

The locking element 1200 comprises an abutting element 1220 configured in such a way that it abuts the contact surface 1130. In a similar manner, the locking element 1300 comprises an abutting element 1320 configured in such a way that it abuts the contact surface 1140. In this specific embodiment, the locking elements 1200, 1300 are substantially provided with a body 1210, 1310 in the shape of a snap ring, meaning substantially the shape of an arc of a circle, with radial extension preferably included between 210 degrees and 350 degrees.

Always in the embodiment illustrated herein, the locking elements 1200, 1300 are also provided with an abutting element 1220, 1320, configured in such a way that it abuts a corresponding contact surface. Specifically, in the embodiment illustrated herein, the abutting element 1220, 1320 is obtained through an extension of the body 1210, 1310 oriented in a substantially radial direction with respect to the body 1210, 1310. More specifically, in the embodiment illustrated herein, the extension of the abutting element 1220, 1320 is oriented towards the inside of the body 1210, 1310. However, the present invention is not limited to this embodiment and an extension oriented towards the outside of the body 1210, 1310 will also be possible. Furthermore, in the embodiment illustrated herein, the length of the abutting element 1320 exceeds the length of the abutting element 1220. This embodiment makes it possible to obtain the contact surfaces 1130, 1140 in a simpler and more effective manner. However, the invention is not limited to this embodiment and it will be possible to implement it with abutting elements 1220, 1320 having the same length.

In the embodiment illustrated in FIG. 1D, the contact surface 1130 is not coplanar with the contact surface 1140. This characteristic, as clearly explained in the description provided below, allows the safety cover to be extracted from the element to be placed in a safe condition S only by staff who know the coding of the coded body 1100.

As can be seen in FIG. 1E, which shows a sectional view of the inner cover 1410, the inner cover 1410 comprises seats 1412, 1413 in a number corresponding to the number of locking elements 1200, 1300. The locking elements 1200, 1300 are inserted in the respective seats 1412, 1413 through the compression of the locking elements 1200, 1300, the respective positioning of the same in the seats and their elastic release. As can also be seen in the figure, the inner cover 1410 is provided with internal grooves 1411. The grooves 1411 have a shape that matches the external shape of the element to be placed in a safe condition S. Specifically, the shape of the grooves 1411 is such as to allow the rotation of the inner cover 1410 on the element to be placed in a safe condition S with clicks. In other words, the size of the grooves 1411 is such that it allows the movement of the inner cover 1410 with respect to the surface of the element to be placed in a safe condition S, but only through the application of a force that must be sufficient to overcome the interaction between the grooves 1411 and the external shape of the element to be placed in a safe condition S. This interaction is constituted by the clicks mentioned above which, as clearly explained below, allow the staff authorized for the removal of the safety cover 1400 to execute the combination associated with the coded body 1100 in such a way as to remove the safety cover 1400. It will be clear, however, that the invention can be implemented also without the grooves 1411, through a simple visual measurement of the rotation angle of the safety cover 1400. In order to facilitate this operation, the safety cover 1400 and/or the coded body and/or the element to be placed in a safe condition S may comprise one or more alignment marks, not illustrated herein.

As can be seen in FIG. 1D, the coded body 1100 comprises a coding cavity 1160 inside which the abutting element 1220 and the abutting element 1320 can be positioned. In the direction of movement of the abutting elements 1220, 1320, the coding cavity is included between the contact surface 1130 and a contact surface 1131 and between the contact surface 1140 and a contact surface 1141. In some embodiments, furthermore, the contact surface 1131 may advantageously not be coplanar with the contact surface 1141.

As can be seen in FIG. 1D, the coded body 1100 comprises a release cavity 1170 connected to the coding cavity 1160, through which the abutting element 1220 and the abutting element 1320 can pass. Specifically, once having been aligned as described below, the locking elements 1200 and 1300, or at least the abutting elements 1220, 1320, can pass through the release cavity 1170 in order to release the safety device 1000.

FIG. 1F shows a sectional view of the inner cover 1410, also visible in FIG. 1E, when mounted on the element to be placed in a safe condition S. FIG. 1G shows a sectional view of the inner cover 1410, also visible in FIG. 1E, together with the remaining part of the inner cover 1410. As can be observed, the terminal portion of the inner cover 1410 comprises one or more thrust elements 1414, for example elastic tabs, configured in such a way as to thrust the inner cover in the opposite direction with respect to the coded body 1100. The thrust elements 1414 are to be considered as optional, as is evident from the following description. In the embodiments including the thrust elements 1414, these make it possible to move the safety cover 1400 away from the coded body. This advantageously makes it possible to insert a part of at least one of the locking elements 1200, 1300, for example the abutting element 1320, into apposite grooves 1120. Consequently, this makes it possible to prevent any accidental movement of the abutting element 1320 with respect to the coded body 1100. Specifically, as the locking elements 1200, 1300 are fitted elastically in the safety cover 1400, they generate friction with respect to the safety cover 1400. This means that when the position of the locking elements 1200, 1300 is fixed the safety cover 1400 can rotate in any case, if a force exceeding the friction present between these elements is applied. On the contrary, if the position of the locking elements 1200, 1300 is not fixed, they rotate together with the safety cover 1400.

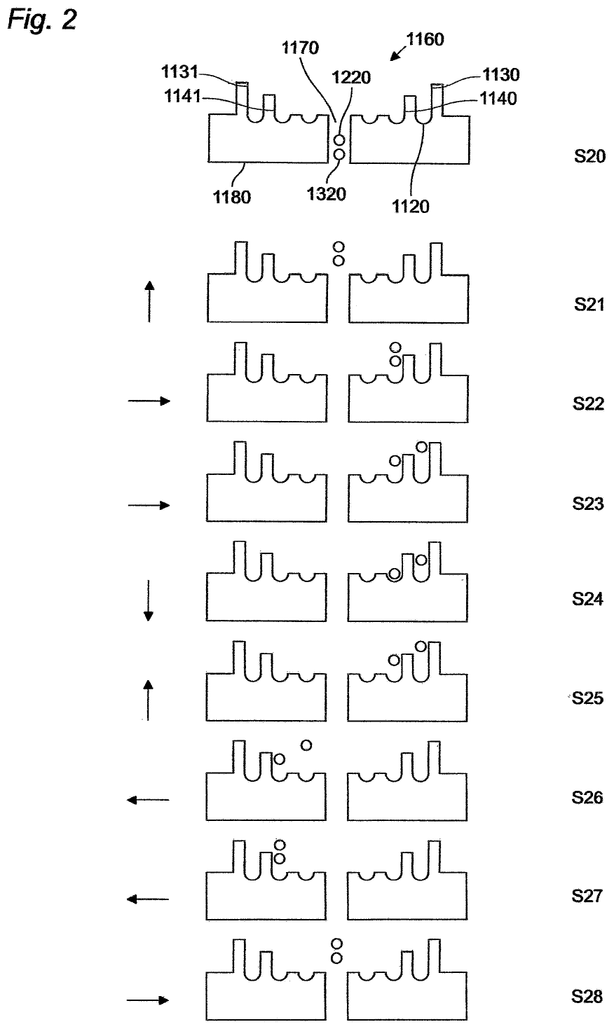

FIG. 2 schematically illustrates a method of use of the embodiment of the invention illustrated in FIGS. 1A to 1G. Specifically, FIG. 2 schematically illustrates a top section view of the locking elements 1200 and 1300, as well as a simplified view of the part of the coded body 1100 which interacts with the locking elements 1200 and 1300. FIG. 2 illustrates different operating steps S20-S28. The movement of the safety cover 1400 with respect to the coded body 1100 is schematically illustrated on the left of each step. As can be seen in FIG. 2, in step S the safety cover 1400 is moved in the direction of the coded body 1100, which results in the insertion of the locking elements 1200 and 1300 through the cavity 1170. In step S21, the locking elements 1200 and 1300 are thus inside the cavity 1160. From this step, a sufficient rotary movement of the safety cover 1400 to the right or to the left locks the safety cover 1400 and prevents its extraction from the coded body 1100.

By way of example, in step S22 the safety cover 1400 is rotated to the right, that is, clockwise, with respect to the coded body 1100. Since the locking elements 1200 and 1300 are positioned inside their seats in the safety cover 1400, in the absence of, other forces acting on them they move together with the safety cover 1400, and parallel, as illustrated above.

At the end of step S22; the abutting element 1320 of the locking element 1300 comes into contact with the contact surface 1140. A successive rotation of the safety cover 1140 does not lead to the rotation of the locking element 1300, which is prevented by the interaction of the abutting element 1320 with the contact surface 1140. On the contrary, since the contact surface 1140 occupies a position inside the cavity 1160 which is not on the plane of movement of the abutting element 1220 of the locking element 1200, a successive rotation of the safety cover 1400 results in a movement of the locking element 1200 leading to the contact with the contact surface 1130, as illustrated in step S23.

At this point, the safety cover cannot be separated from the coded body 1100. Actually, the abutting elements 1220, 1320 would come into contact with the grooves 1120, or with the coded body, if the cavities 1120 were not present, thus preventing the separation of the safety cover 1400 from the coded body 1100. The pressure exerted on the safety cover 1400 can thus be interrupted. The thrust elements 1414, which in this case are provided, make at least the abutting element 1320 enter a groove 1120, which advantageously prevents any accidental movement of the locking element 1300 with respect to the coded body 1100, thanks to the frictional assembly of the locking element 1300 in the safety cover 1400. At this point, a random clockwise or anticlockwise rotation of the safety cover 1400 does not allow the separation of the safety cover 1400 from the coded body 1100. First of all, this happens because the rotation of the locking element 1300 would be impossible, being prevented by the fact that it is positioned in the groove 1120. In any case, even if pressure is exerted on the thrust elements 1414, or if these are not provided, since the two locking elements 1200, 1300 are not aligned any more, it is not possible to extract both the abutting elements 1220 and 1320 from the cavity 1170.

In greater detail, as illustrated in steps S and S26, an anticlockwise movement makes the locking element 1320 rest against the contact surface 1141. The uncontrolled continuation of the rotation would cause the locking element 1220 to rest against the contact surface 1131, thus returning to a locked configuration. On the contrary, as illustrated in step S27, a controlled anticlockwise rotation results in the alignment of the locking elements 1220 and 1320. At this point, as shown in step S28, it is possible to move the two locking elements 1220 and 1320 above the cavity 1170 and proceed to release the device 1000.

The alignment of the locking elements 1220, 1320 thus depends on the relative position of the contact surfaces 1130, 1131, 1140 and 1141, so that only those who know their position and the rotary movement or the combination required to align the locking elements 1220, 1320 can release the device 1000.

It will be clear that, in the situation described above, in the presence of the thrust elements 1414, the rotation steps are possible only if a thrusting action allows the locking elements 1220, 1320 to be released from the grooves 1120. The use of the combination, in the presence of the thrust elements 1414, thus requires the correct application of thrusting and rotation movements together. Furthermore, it will be clear that alternative embodiments can be implemented, in which the device can be configured in such a way that instead of thrusting the safety cover 1400 to release the locking elements 1220, 1320 so as to allow them to rotate together with the safety cover 1400, it will be necessary to pull the safety cover 1400.

In some embodiments, the distance between the contact surface 1130, 1131 and the release cavity 1170 and/or the distance between the surface 1140, 1341 and the release cavity 1170 depends on the position of the grooves 1411, and is preferably equal to the angular dimension of a plurality of grooves 1411, even more preferably equal to a multiple of the angular dimension of one of the grooves 1411. In some embodiments, the angular dimension of the grooves 1120 corresponds to the angular dimension of the abutting elements 1220, 1320. Consequently, the size of the cavity 1160 depends on the size of the grooves 1120 and the cavity 1170. The grooves 1411 are positioned in such a way as to produce a noise, or a click, which takes place through the interference between the grooves 1411 and the external shape of the element S during rotation. The angular dimension of the grooves 1411 can thus be calculated in such a way as to obtain that the noise or click corresponds to the distance covered by the locking element 1200, 1300 between a groove 1120 and the successive one. This solution is particularly advantageous, since the combination, instead of being expressed in rotation angles, can be expressed as the number of clicks produced by the grooves 1411 on the element S or the coded body 1100. Since the distances that define the combination are equal to a multiple of the angular dimension of the grooves, the combination will thus be easy to memorize as a number of clicks in one or more directions rather than as a rotation by a certain angle.

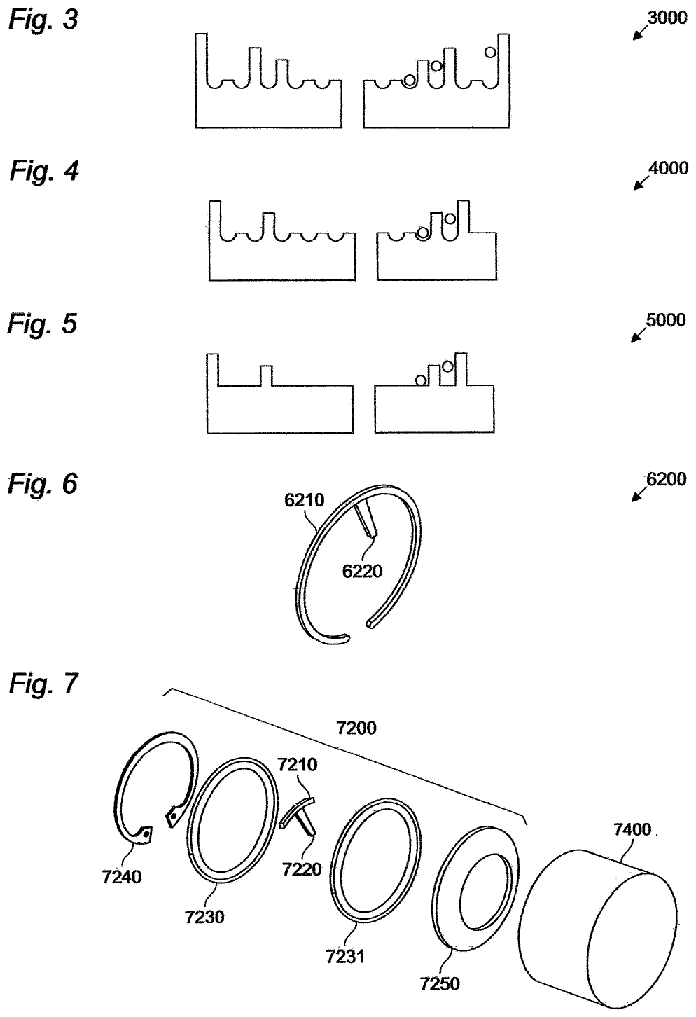

FIGS. 3 to 6 schematically illustrate alternative embodiments of the invention.

Specifically, FIG. 3 illustrates an embodiment with three locking elements instead of the two locking elements described above. Also in this case, the lack of coplanarity between at least two of the contact surfaces results in the misaligned positioning of the respective locking elements, so that one or more rotations according to a predetermined combination are required to align the locking elements again and proceed to release the device.

FIG. 4 schematically illustrates an embodiment in which, contrary to the explanation provided above, the position of the contact surfaces is not symmetrical with respect to the cavity 1170. The invention can work also in this case.

FIG. 5 schematically illustrates an embodiment in which there are no grooves 1120. The invention can work also in this case, since the misaligned configuration that stops the locking elements does not depend on the presence of the grooves 1120.

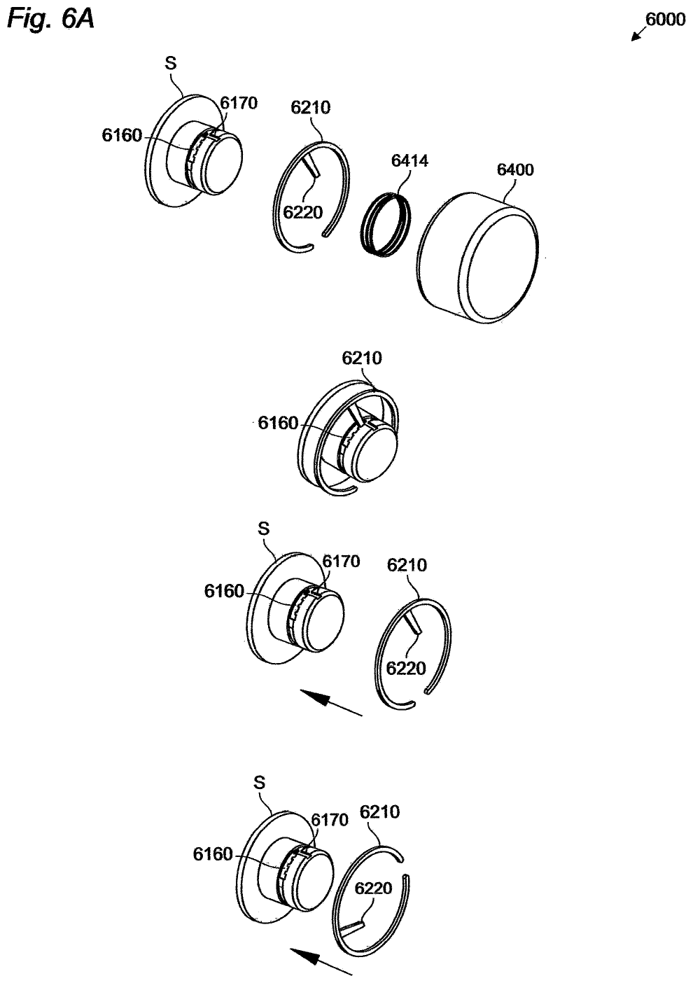

FIG. 6 schematically illustrate a locking element 6200, which is a possible variant of the locking element 1200 and/or of the locking element 1300 described above. Specifically, the locking element 6200 comprises an abutting element 6220 that is not positioned at one end of the body 6210, as described above with reference to the locking element 1200, but rather in a part of the body 6210 which is included between its two ends, preferably in a substantially median position with respect to the two ends. It will be clear that the invention can work in a similar manner if one or more of the locking elements 1200, 1300 is/are replaced with a locking element 6200.

FIG. 7 schematically illustrates a locking element 7200, which is a possible variant of the locking element 1200 and/or of the locking element 1300 and/or of the locking element 6200 described above. Specifically, the locking element 7200 comprises an abutting element 7220 positioned in a part of the body 7210 which is included between the two ends of the body 7210. In this case, the body 7210 has the shape of an arc of a circle with an angle preferably smaller than 180°, more preferably smaller than 90°. Since in this case an elastic insertion as in the cases described above is not possible, in order to prevent the locking element 7200 from moving with respect to the safety plug 7400 two sealing rings 7230, 7231 are used, between which the locking element 7200 is kept pressed. The pressure is obtained by means of a thrust ring 7250, whose shape is such as to exert an elastic thrusting action in the longitudinal direction of extension of the safety cover 7400, and of a locking ring 7240, for example a snap ring. It will thus be clear that the safety cover 7400 comprises at least one seat for the locking ring 7240, even if not shown. It will be clear that the invention can work in a similar manner if one or more of the locking elements 1200, 1300, 6200 is/are replaced with a locking element 7200.

In some embodiments, visible for example in FIG. 6, the locking element 6200 comprises a body 6210 which describes a plane. In other words, there is a plane that includes the body 6210. The abutting element 6220 can also belong to the plane or it can be inclined with respect to said plane, preferably with an angle included between 5° and 20°. The inclination of the abutting element 6220 allows the safety cover 1400 to behave elastically while being fitted on the coded body 1100 and to thrust against the grooves 1120, or in any case against the corresponding surface if they are not provided, in response to an attempt to separate the safety cover 1400 from the coded body 1100. This characteristic advantageously makes it possible to fit the safety cover 1400 on the coded body 1100 independently of the alignment between the abutting element 6220 and the release cavity 1170. On the contrary, what has been described above applies for the release operation.

According to a further embodiment, visible in FIG. 6A, the locking element 6200 is used in a safety device 6000 comprising the locking element 6200, so that it is possible to lock a safety cover 6400 on the element S. The safety cover 6400 is thrust in the opposite direction with respect to the element S by a thrust element 6414, for example a spring or magnets. Thanks to the advantageous shape of the locking element 6200, the abutting element 6220 does not necessarily need to be inserted through the locking cavity 6170. On the contrary, as can be seen in FIG. 6A, it is possible to insert the abutting element 6220 in any position, thanks to its elastic behaviour. However, as in the previous examples and thanks to the shape of the locking element 6200, its extraction will be possible only through the locking cavity 6170. The thrusting action of the thrust element 6414 guarantees that the extraction is not possible in any other way.

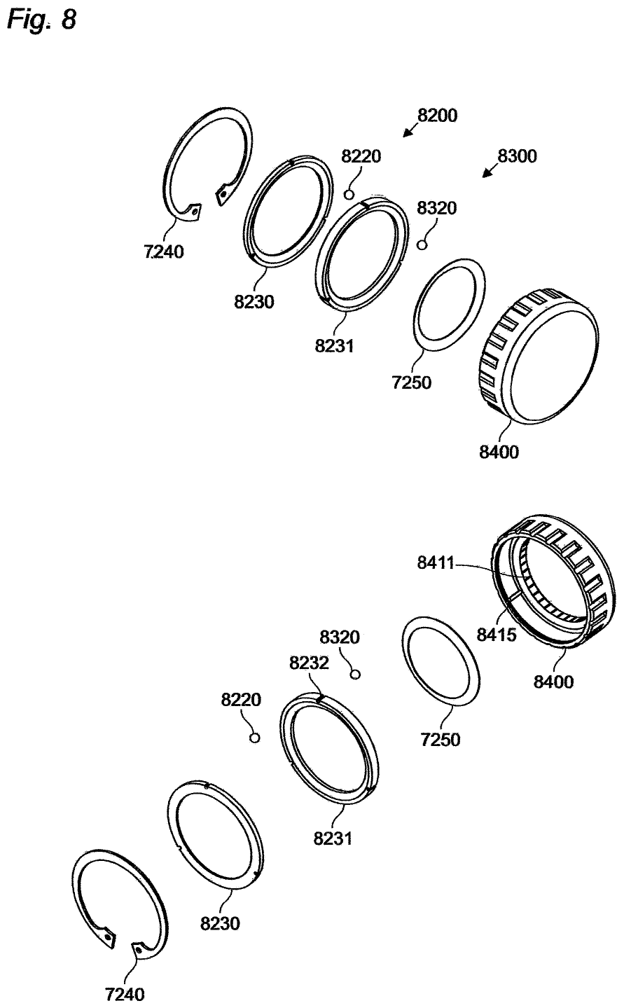

FIG. 8 schematically illustrates a locking element 8200, 8300, which is a possible variant of the locking element 1200 and/or of the locking element 1300 and/or of the locking element 6200 and/or of the locking element 7200 described above. Specifically, the locking element 8200, 8300 comprises an abutting element 8220, 8320 in a substantially spherical shape. Since also in this case an elastic insertion as in the cases described above is not possible, in order to prevent the abutting element 8220, 8320 from moving with respect to the safety plug 8400 two sealing rings 8230, 8231 are used, between which the abutting element 8220 is kept pressed. The combination of the sealing rings 8230, 8231 and the abutting element 8220 thus produces the locking element 8200. Analogously, the abutting element 8320 is kept pressed between the sealing ring 8231 and the thrust ring 7250, which works as described above. It will be clear that the invention can work in a similar manner if one or more of the locking elements 1200, 1300, 6200, 7200 is/are replaced with a locking element 8200, 8300.

In the embodiment illustrated above, the safety cover 8400 comprises grooves 8411 whose function is similar to that of the grooves 1411 described above. It is clear that also in this case the invention can be carried out without the grooves 8411.

In the embodiment illustrated above, the safety cover 8400 comprises one or more anti rotation teeth 841 corresponding to one or more anti rotation notches 8232 respectively provided in the sealing ring 8230, 8231. These characteristics, which should be considered optional, prevent the rotation of the sealing ring 8230, 8231 with respect to the safety cover 8400.

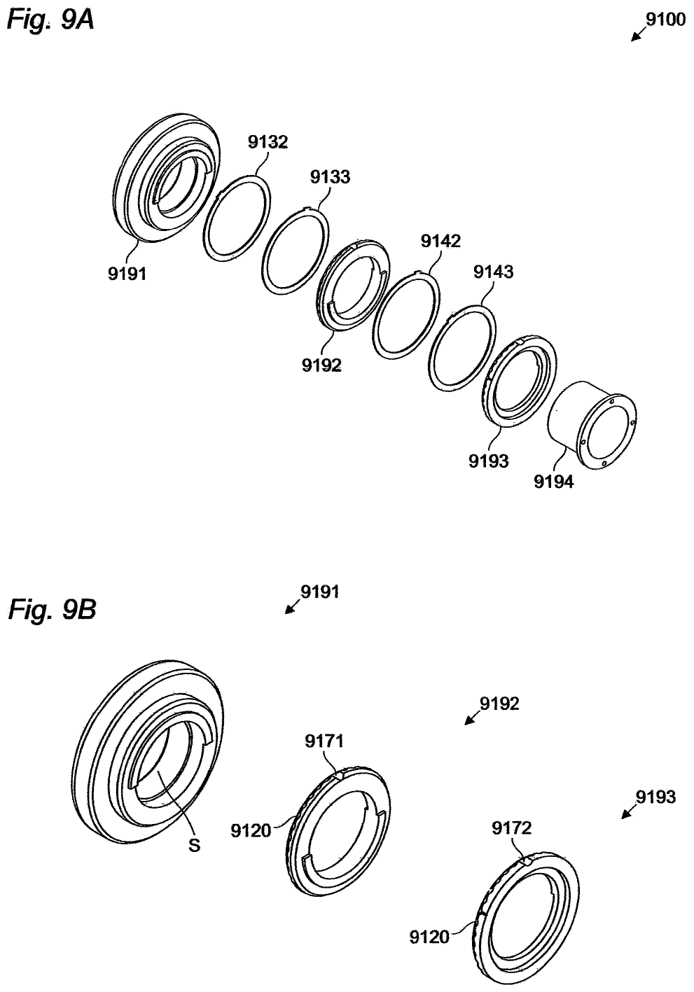

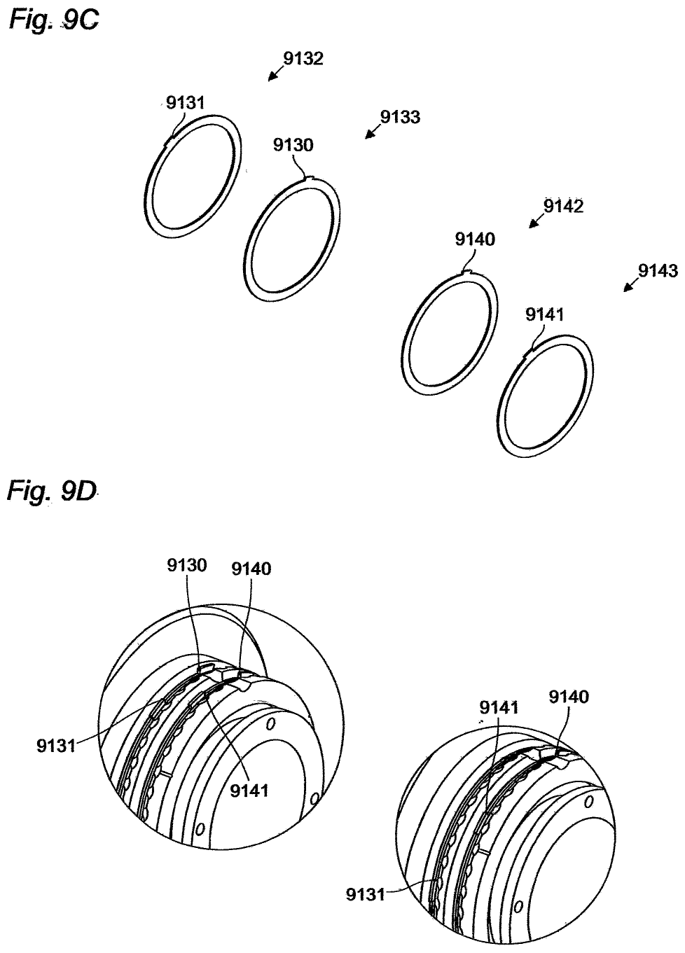

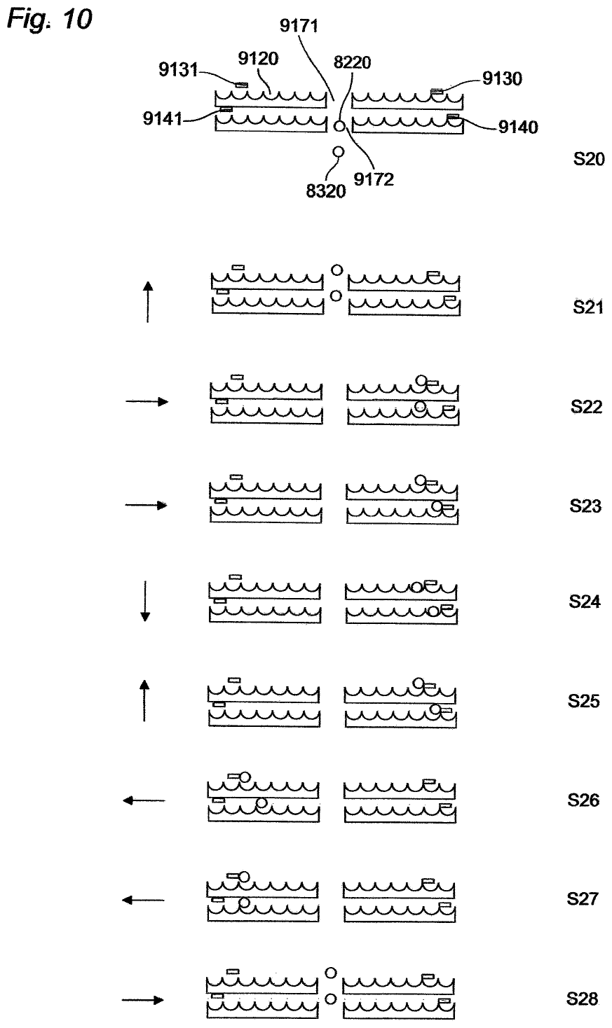

FIGS. 9A to 9D schematically show a coded body 9100 according to an alternative embodiment of the invention. Specifically, the coded body 9100 differs from the coded body 1100 as it allows the combination, or the coding of the coded body, to be programmed.

More specifically, the coded body 9100 comprises at least one abutting ring 9133 and one abutting ring 9142, wherein the abutting ring 9133 comprises a contact surface 9130 and wherein the abutting ring 9142 comprises a contact surface 9140. The function of the two contact surfaces 9130 and 9140 is similar to that of the contact surfaces 1130 and 1140 described above. In addition to the above, the coded body 9100, as illustrated, comprises an abutting ring 9132 and an abutting ring 9143, wherein the Abutting ring 9132 comprises a contact surface 9131, and wherein the abutting ring 9144 comprises a contact surface 9141, whose function is similar to that of the contact surfaces 1131 and 1141. It will be clear that, although in the embodiment illustrated above there are four abutting rings, each one with a single contact surface, it will be possible to implement two contact surfaces in a single abutting ring, thus reducing the possibility to configure the coded body, but in any way maintaining a possibility of configuration. Two different configurations of the contact surfaces are illustrated, for example, in the two examples of FIG. 9D.

In order to allow the modification of the combination of the coded body 9100, the abutting rings can be moved with respect to each other in a coding position of the coded body 9100 and are fixed with respect to each other in a locking position of the coded body 9100. The passage between the locking position and the coding position can be obtained in different manners, for example by exerting pressure on the rings so that they are locked due to the friction that is generated or inserting locking elements in suitable slots provided in the abutting rings, not illustrated herein, in such a way as to prevent their mutual movement. In the embodiment illustrated, the coded body 9100 comprises a plurality of locking rings 9191, 9192, 9193 between which the abutting rings are positioned. The number of locking rings illustrated is three; however it is clear that the invention can also be carried out only with the locking rings 9191 and 9193. In the embodiment illustrated, the locking rings produce friction and thus lock the abutting rings 9132, 9133, 9142, 9143 and are fitted on a supporting element 9194. The supporting element 9194 can be threaded, in order to allow one or more of the locking rings 9191-9193, preferably the locking ring 9191, to be screwed therein, in such a way as to exert pressure on the abutting rings and thus pass from the coding position, when loosening, to the locking position, when tightening.

In the embodiment illustrated, the supporting element 9194 has a hollow cylindrical shape, in such a way as to allow access to the hole to be placed in a safe condition S. It will be clear; however, that alternatively any shape allowing the assembly of the abutting rings and the locking rings can be implemented.

In the embodiment illustrated, the locking rings have complementary surfaces, so that in the locking position the complementary surfaces of two adjacent locking rings mesh with each other in order to prevent the mutual rotation of the locking rings. In the embodiment illustrated, the complementary surfaces are obtained through a half-cylinder which extends from the surface of each one of the locking rings in the longitudinal direction of extension of the supporting element 9194. This configuration advantageously makes it possible to avoid the rotation between the locking rings and, since the two complementary half-cylinders form a complete cylinder, provides also a cylinder on which the abutting rings 9132, 9133, 9142, 9143 can be assembled.

In some embodiments not illustrated herein, it will be possible to create an external surface of the half-cylinders which at least partially comprises locking teeth intended to interact with locking cavities provided in the abutting rings 9132, 9133, 9142, 9143. In this way, it will be possible to lock the abutting rings in a specific position, thanks to the fixing obtained between the locking teeth and the locking cavities during the assembly of the coded body 9100.

FIG. 10 schematically shows a method of use of the coded body 9100. The method is substantially similar to that already described with reference to FIG. 2. In this case, the embodiment illustrated comprises two locking rings 9192, 9193 with two release cavities 9171, 9172. It will be clear, however, that in alternative embodiments it will be possible to obtain a similar function by using a single locking ring 9193 and a single release cavity 9172. In the embodiments illustrated in FIGS. 9A-9D and 10, the locking rings 9192, 9193 comprise grooves 9120 whose function is similar to that of the grooves 1120 described above. Therefore, the observations on the function and the optional presence of the grooves 1120 apply also to the grooves 9120.

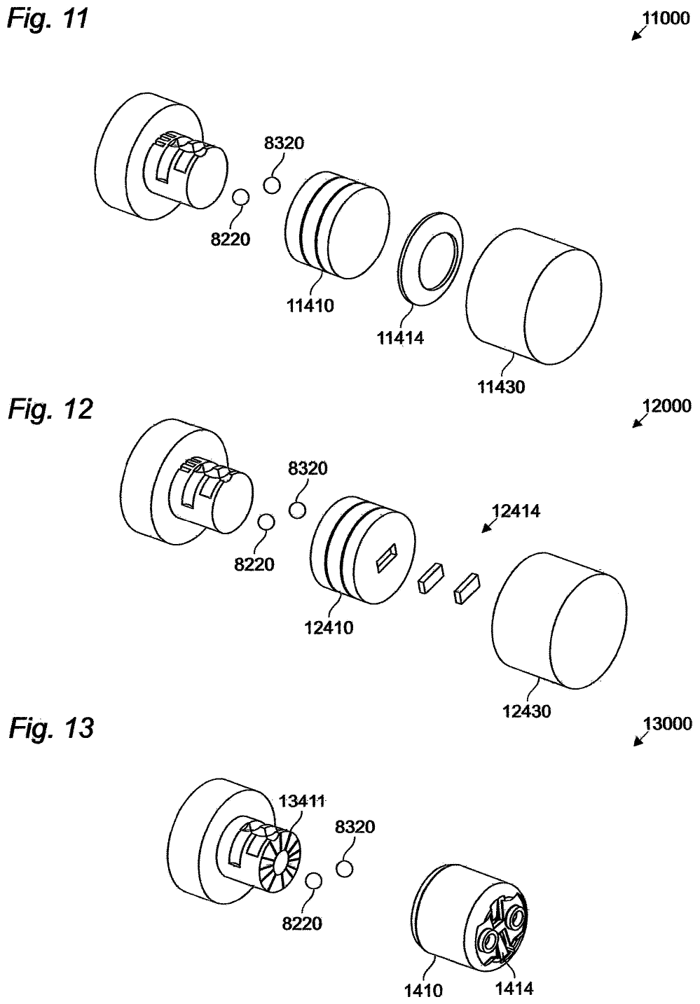

FIGS. 11, 12, 13 14A and 14B schematically show safety devices 11000, 12000, 13000, 14000 according to alternative embodiments of the invention.

Specifically, each one of the safety devices 11000-13000 comprises abutting elements 8220, 8320 similar to those previously described with reference to FIG. 8. Differently from FIGS. 9A-9D and 10, none of the devices 11000-13000 is provided with the grooves 9120 in the cavity of the coded body. It is possible, however, to prevent any accidental movement of the safety plug with respect to the coded body by applying pressure between the abutting elements 8220, 8320 and the coded body. In the case of FIG. 11, pressure is exerted by a thrust element 11414, for example a spring, positioned between the inner cover 11410 and the outer cover 11430. In the case illustrated in FIG. 12, the thrust element 12414 is constituted by two magnets positioned between the inner cover 12410 and the outer cover 12430 in such a way as to mutually repel each other and thus move the inner cover 11410 away from the outer cover 11430. In the case of FIG. 13, the thrust elements 1414 described above are used. It will be clear that the thrust elements 11414, 12414 can be used also in embodiments comprising locking elements different from the locking elements 8200, 8300.

In the embodiment illustrated in FIG. 13, it is also possible to observe grooves 13411 located on the external surface 1180 of the coded body. The function of the grooves 13411 is similar to that of the grooves 1411, 8411 described above, and they serve as elements suited to produce the clicks described above when the safety cover is rotated.

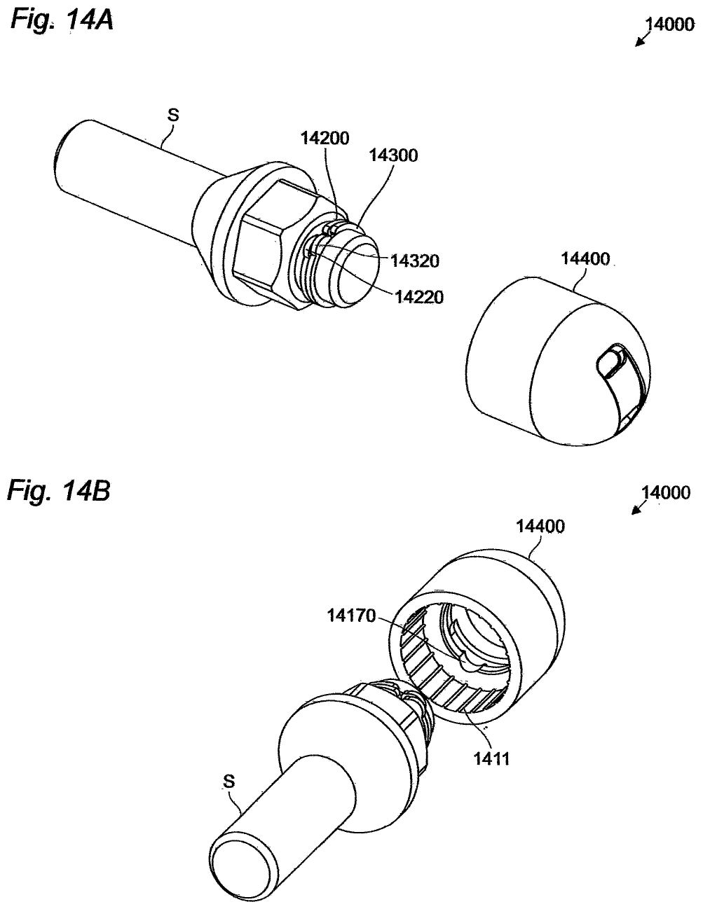

The embodiment illustrated in FIG. 14 differs from all the previous embodiments in that the locking elements 14200, 14300 are assembled on the element to be placed in a safe condition S, instead of on the safety cover, and the coded body is executed in the safety cover 14400. In the embodiment illustrated, the locking elements 14200 and 14300 are similar to the locking elements 1200, 1300, the only difference lying in that the abutting elements 14220, 14320 are oriented in the direction of the safety cover 14400. In other words, the shape of the locking elements 14200 and 14300 allows them to behave elastically, so that they can be fitted on the element S through friction. In this case, the elastic force acts through compression rather than through expansion, as in the case of the locking elements 1200, 1300. Consequently, the abutting elements, instead of being oriented towards the inside of the locking elements, as in the case of the locking elements 1200, 1300, are oriented towards the outside of the same. The safety device 14000 can thus be used to cover an element or hole S to be placed in a safe condition, and comprises a safety cover 14400, and a locking element 14200 and a locking element 14300 positioned between the safety cover 14400 and the element or hole S to be placed in a safe condition. It is clear that instead of one or more of the locking elements 14200, 14300 illustrated above it will be possible to use any of the locking elements 1200, 6200, 7200, 8200 with suitable modifications which will be evident to the experts in the art.

The safety cover 14400 comprises a contact surface which, for example, is similar to the contact surface 1130, 9130 and a contact surface which, for example, is similar to the contact surface 1140, 9140. The locking element 14200 comprises an abutting element 14220 configured in such a way that it abuts a first contact surface and the locking element 14300 comprises an abutting element 14320 configured in such a way that it abuts a second contact surface, in a manner similar to that described above. As in the previous cases, the fact that the first contact surface is not coplanar with the second contact surface makes it possible to lock the safety cover as described, for example, in relation to FIGS. 2 and 10.

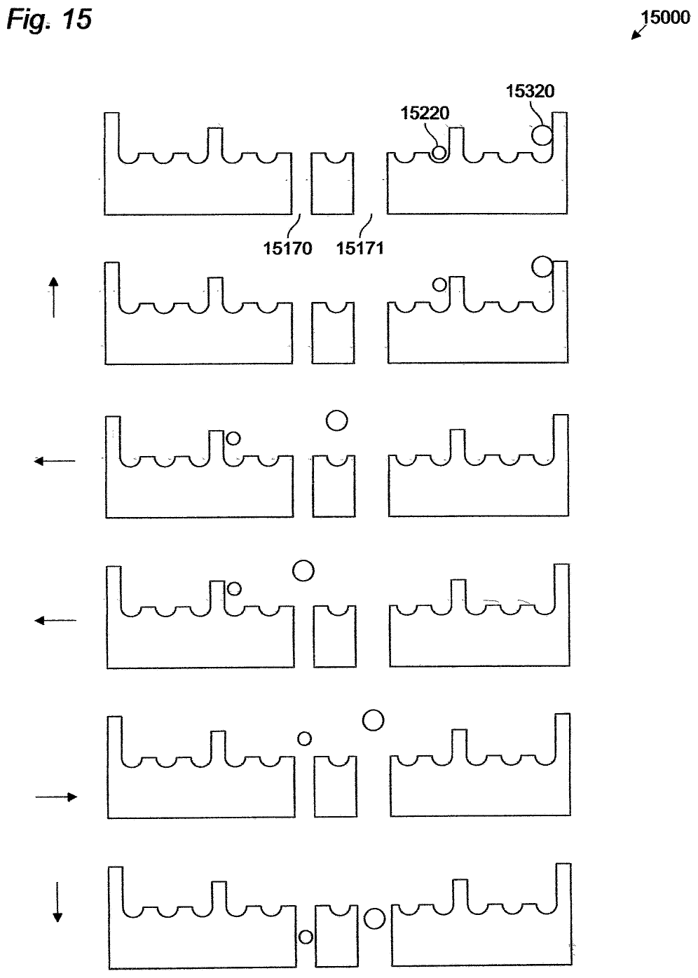

FIG. 15 schematically shows a safety device 15000 according to an alternative embodiment of the invention and the respective method of use. Specifically, the safety device 15000 presents two differences with respect to the safety devices previously described, which can also be carried out independently and even in combination with each one of the safety devices previously described. More specifically, in the safety device 15000 the sectional size of the abutting elements 15220 and 15320 is different, and furthermore the release cavities are more than one. As is clear from the previous description and as can be seen in FIG. 15, in order to release the safety element 15000 it is thus necessary to align the correct abutting element with the correct release cavity, for example the larger abutting element 15320 with the respective release cavity 15171.

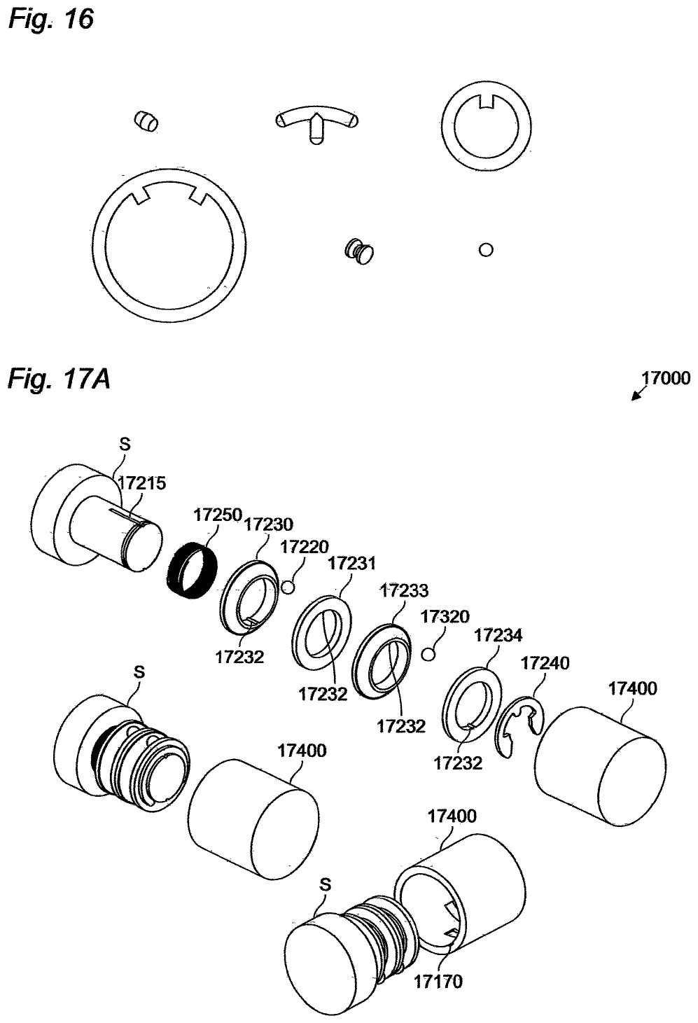

FIG. 16 schematically shows locking elements according to alternative embodiments of the invention. Specifically, as is evident from the examples illustrated in FIG. 16 and from the preceding description, it is sufficient for the shape of the locking element, and more specifically of the abutting element, to project towards the coding cavity, or towards the respective contact surface. Therefore, any of the locking elements shown in FIG. 16 can be used instead of any of the locking elements previously described.

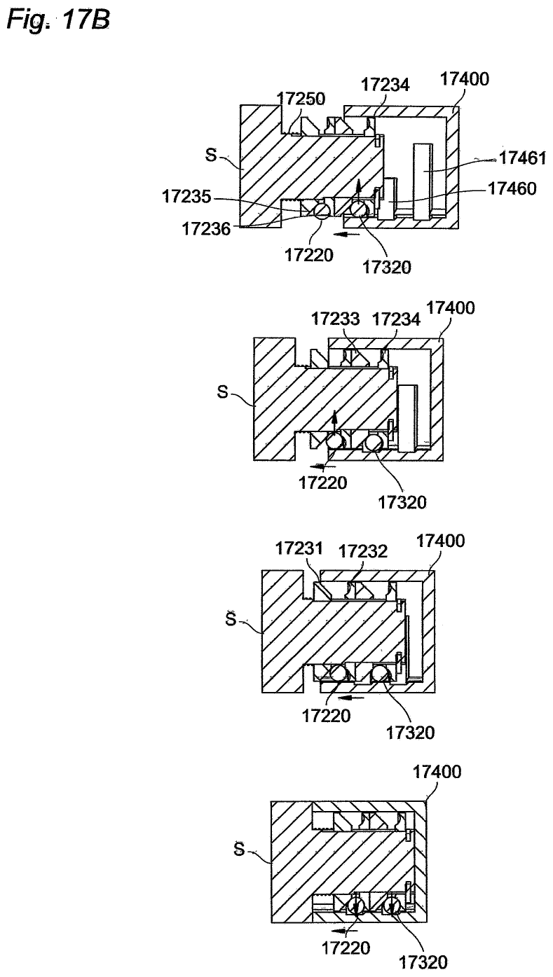

FIGS. 17A and 17B schematically show a safety device 17000 according to an alternative embodiment of the invention.

In this embodiment, the locking elements are fitted on the element to be placed in a safe condition S and the abutting elements 17220, 17320 are obtained by means of spheres maintained in position by sealing rings 17230, 17231, 17233, 17234. As already described, instead of the spheres it will be possible to use other abutting elements, for example one of those shown in FIG. 16.

As far as the release operation is concerned, this embodiment works in a manner similar to that discussed in relation to FIGS. 14A and 14B, in which also the locking elements are positioned on the element to be placed in a safe condition S. Also in this case, therefore, the release will take place through the alignment of the abutting elements 17220, 17320 in the respective cavity provided inside the safety cover 17400.

Differently from FIGS. 14A and 14B, however, this embodiment uses abutting elements 17220, 17320 similar to those used in the embodiments shown in FIG. 8, also for the purpose of clarifying how the different embodiments can be combined with each other.

Furthermore, this embodiment adds a characteristic that allows the abutting elements 17220, 17320 of this type to behave similarly to the abutting element 6220. In other words, this embodiment makes it possible to fit the safety cover 17400 on the element to be placed in a safe condition S also in the presence of abutting elements 17220, 17320 not necessarily aligned with the release cavity 17170.

This is possible because at least some of the locking rings are movable along the element to be placed in a safe condition S and kept pressed by the thrust ring 17250, for example a spring. Specifically, as can be seen more easily in FIG. 17B, when the abutting element 17320 comes into contact with the safety cover 17400, it is pushed towards the element to be placed in a safe condition S. The movement is possible because the sealing ring 17233 can be moved to the left, thus leaving more space between the sealing rings 17233 and 17234, in which the abutting element 17320 can be inserted.

When the abutting element 17320 enters the coding cavity 17460, the thrusting force exerted by the thrust ring 17250 moves the abutting element 17320 back to its most external position, in such a way that the latter fits into the coding cavity. The same mechanism can be applied to the insertion of the abutting element 17320 in the coding cavity 17461 and to the insertion of the abutting element 17220 in the coding cavity 17460. It is therefore possible, as in the case of the abutting element 6220, to insert the abutting element in the respective coding cavity with no need to pass through the release cavity 17170.

Furthermore, it is advantageously possible to prevent the extraction if the abutting elements 17220, 17320 are not aligned with the release cavity 17170.

This is advantageously obtained by making the sealing rings 17230 and 17231, as well as the sealing rings 17233 and 17234, in an asymmetrical manner.

Specifically, as can be more easily seen in FIG. 17B, the sealing ring 17230 comprises an oblique surface 17235, while the sealing ring 17231 comprises a surface 17236 which is at least partially complementary to the shape of the abutting element 17220.

During the insertion, the abutting element 17220 is pushed outside of the complementary surface 17236 and along the oblique surface 17235. Thanks to the angular position of the oblique surface 17235, this results in a thrusting action of the sealing, ring 17230 to the left, thus opening a space between the sealing rings 17230 and 17231, as previously described. During the extraction of the safety cover 17400, the abutting element 17220 is pushed against the complementary surface 17236. Thanks to the fact that the external shape of the abutting element 17220 matches that of the complementary surface 17236, the abutting element 17220 remains confined by the complementary surface 17236 and cannot move, thus preventing the extraction of the safety cover 17400. It will be clear that this behaviour can be applied in a similar manner to the abutting element 17320. In some embodiments, furthermore, anti-rotation notches 17215 can be 5 provided, which cooperate with anti-rotation teeth 17232 in order to avoid the rotation of the sealing rings. Furthermore, the length of the different anti rotation notches 17215 along the element to be placed in a safe condition S can be different, in such a way as to define the maximum position that can be reached by the sealing rings along the element to be placed in a safe condition S.

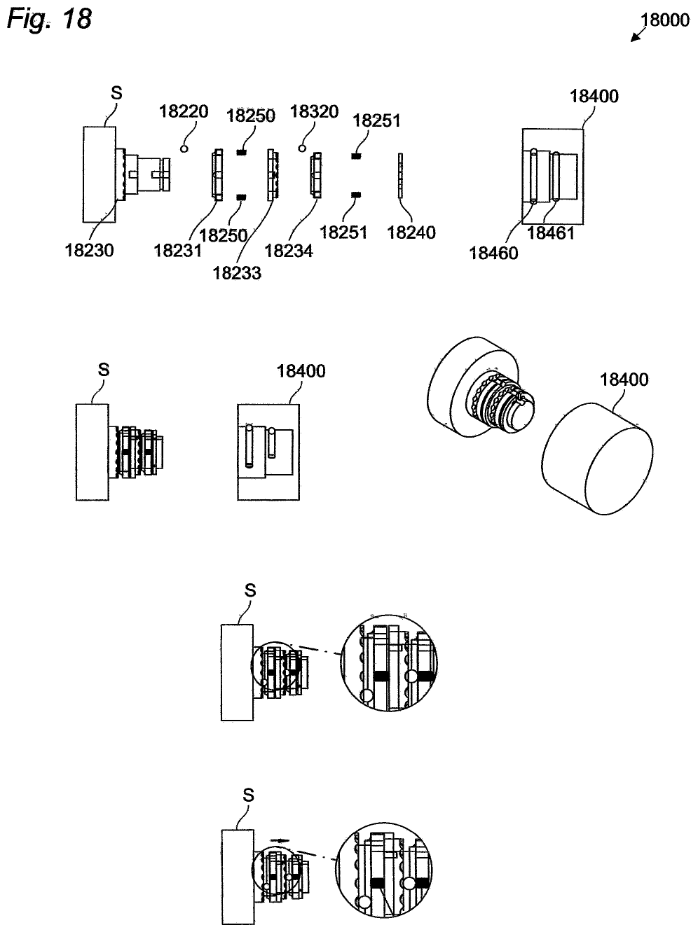

FIG. 18 schematically shows a safety device 18000 according to an alternative embodiment of the invention.

In this case, the thrust elements 18250, 18251 are positioned between the sealing rings 18230, 18231, 18233, 18234.

At least the sealing rings 18230, 18232 are provided with grooves that allow the partial insertion of the abutting elements 18220, 18320. Thanks to the possibility of movement offered by the thrust elements 18250, 18251, for example springs or magnets, the sealing rings 18231 and 18233 can move along the element to be placed in a safe condition. In this way, it is possible to release the abutting elements 18220, 18320, which otherwise are held in a fixed position between the respective sealing rings.

Thus, more specifically, pulling the element to be placed in a safe condition S, or the safety cover 18400, makes the abutting elements 18220, 18320 rest against a surface which limits the coding cavity 18460, 18461, especially along the surface which is substantially parallel to the sealing rings 18230,18231, 18233, 18234 and positioned, for the respective coding cavity 18460, 18461, towards the direction of extraction of the abutting elements 18220, 18320. In this manner, by pulling the safety cover 18400 it is possible to release the abutting elements 18220, 18320 from the respective sealing rings 18230, 18231, 18233, 18234, thus allowing the abutting elements 18220, 18320 to move with respect to the element to be placed in a safe condition S.

In this embodiment it will consequently be possible to implement a combination according to which the safety cover 18400 is pulled and rotated so as to extract it from the element to be placed in a safe condition S.

Even though, for the sake of clarity, in the description provided above the different embodiments have been described independently, each with a specific set of characteristics, it is clear that subsets of characteristics of any embodiment can be implemented, in such a way as to obtain a new embodiment. It will also be clear that any number of characteristics of an embodiment can be implemented together with any number of characteristics of one or more other embodiments, in such a way as to obtain a new embodiment. Thus, the possible embodiments of the invention are not limited to those described above but include any embodiment falling within the scope defined by the following claims.

### LIST OF THE REFERENCE NUMERALS

1000: safety device
1100: coded body
1110: fixing element
1120: grooves
1130, 1131, 1140, 1141: contact surface
1150: external surface
1160: coding cavity
1170: release cavity
1180: external surface
1200, 1300: locking element
1210, 1310: body
1220, 1320: abutting element
1400: safety cover
1410: inner cover
1411: grooves
1412, 1413: seat
1414: thrust element
1420: anti perforation element
1430: outer cover
S: element to be placed in a safe condition
S20-S28: method of use
3000: safety device
4000: safety device 5000: safety device
6000: safety device
6160: coding cavity
6170: release cavity
6200: locking element
6210: body
6220: abutting element
6400: safety cover
6414: thrust element
7200: locking element
7210: body
7220: abutting element
7230, 7231: sealing ring
7240: locking ring
7250: thrust ring
7400: safety cover
8200, 8300: locking element
8220, 8320: abutting element
8230, 8231: sealing ring
8232: anti rotation notches
8400: safety cover
8411: grooves 8415: anti rotation teeth
9100: coded body
9120: grooves
9130, 9131, 9140, 9141: contact surface
9132, 9133, 9142, 9143: abutting ring
9171, 9172: release cavity
9191, 9192, 9193: locking ring
9194: supporting element
11000: safety device
11410: inner cover
11430: outer cover
11414: thrust element
12000: safety device
12410: inner cover
12430: outer cover
12414: thrust element
13000: safety device
13411: grooves
14000: safety device
14170: release cavity
14200, 14300: locking element
14220, 14320: abutting element
14400: safety cover
15000: safety device
15170, 15171: release cavity
15220, 15320: abutting element
17000: safety device
17170: release cavity
17215: anti rotation notches
17220, 17320: abutting element
17230, 17231, 17233, 17234: sealing ring
17232: anti rotation teeth
17235: oblique surface
17236: complementary surface
17240: locking ring
17250: thrusting ring
17400: safety cover
17460, 17461: coding cavity
18000: safety device
18220, 18320: abutting element
18230, 18231, 18233, 18234: sealing ring
18240: locking ring
18250, 18251: thrust element
18400: safety cover
18460, 18461: coding cavity

1. A safety device (1000, 3000, 4000, 5000, 6000, 11000, 12000, 13000, 15000, 17000) designed to cover an element or hole (S) to be placed in a safe condition, the safety device comprising:
a coded body (1100, 9100),
a safety cover (1400, 7400, 8400),
a first locking element (1200, 6200, 7200, 8200) and a second locking element (1300, 6200, 7200, 8300) positioned between the coded body (1100, 9100) and the safety cover (1400, 7400, 8400),
wherein the coded body (1100, 9100) comprises a first contact surface (1130, 9130) and a second contact surface (1140, 9140),
wherein the first locking element (1200, 6200, 7200, 8200) comprises a first abutting element (1220, 6220, 7220, 8220) configured so that it abuts the first contact surface (1130, 9130),
wherein the second locking element (1300, 6200, 7200, 8300) comprises a second abutting element (1320, 6220, 7220, 8320) configured so that it abuts the second contact surface (1140, 9140),
wherein the first contact surface (1130, 9130) is not coplanar with the second contact surface (1140, 9140),
characterized in that
the coded body (1100, 9100) comprises a coding cavity (1160) inside which the first abutting element (1220, 6220, 7220, 8220) and the second abutting element (1320, 6220, 7220, 8320) can be at least partially positioned, and in that the coded body (1100, 9100) comprises a release cavity (1170, 9171, 9172, 15170, 15171, 17170) connected with the coding cavity (1160), through which the first abutting element (1220, 6220, 7220, 8220) and/or the second abutting element (1320, 6220, 7220, 8320) can pass.

2. The safety device (1000, 3000, 4000, 5000, 6000, 11000, 12000, 13000, 14000, 15000, 17000) according to claim 1,
wherein the coded body (1100, 9100) comprises a third contact surface (1131, 9131) and a fourth contact surface (1141, 9141),
wherein the third contact surface (1131, 9131) is not coplanar with the fourth contact surface (1141, 9141).

3. The safety device (1000, 3000, 4000, 5000, 6000) according to claim 1,
wherein the first abutting element (1220, 6220, 7220) is longer than the second abutting element (1320, 6220, 7220).

4. The safety device (1000, 3000, 4000, 5000, 6000, 11000, 12000, 13000, 14000, 15000, 17000) according to claim 1,
wherein the coding cavity (1160) is included between the first contact surface (1130, 9130) and the third contact surface (1131, 9131) and between the second contact surface (1140, 9140) and the fourth contact surface (1141, 9141).

5. The safety device (1000, 3000, 4000, 5000, 6000, 11000, 12000, 13000, 14000, 15000, 17000) according to claim 1,
wherein the safety cover (1400, 7400, 8400) comprises grooves (1411, 8411).

6. The safety device (1000, 3000, 4000, 5000, 6000, 11000, 12000, 13000, 14000, 15000, 17000) according to claim 1,
wherein the distance between the first contact surface (1130, 9130) and the release cavity (1170, 9171, 9172, 15170, 15171, 17170) and/or the distance between the second contact surface (1140, 9140) and the release cavity (1170, 9171, 9172, 15170, 15171, 17170) depends on the position of the grooves (1411, 8411), and is preferably equal to the angular dimension of a plurality of grooves (1411, 8411), even more preferably equal to a multiple of the angular dimension of one of the grooves (1411, 8411).

7. The safety device (1000, 3000, 4000, 5000, 6000, 11000, 12000, 13000, 14000, 15000, 17000) according to claim 1,
wherein the safety cover (1400, 7400, 8400) comprises a first seat (1412) for the first locking element (1200) and a second seat (1413) for the second locking element (1300).

8. The safety device (1000, 3000, 4000, 5000, 6000, 17000) according to claim 1,
wherein the first locking element (1200, 6200, 7200) comprises a first body (1210, 6210, 7210),
wherein the first body (1210) describes a first plane,
wherein the first abutting element (1220, 6220, 7220) is inclined with respect to the first plane.

9. The safety device (1000, 3000, 4000, 5000, 6000, 11000, 12000, 13000, 14000, 15000, 17000) according to claim 1,
wherein the coded body (9100) comprises a first abutting ring (9133) and a second abutting ring (9142),
wherein the first abutting ring (9133) comprises the first contact surface (9130), wherein the second abutting ring (9142) comprises the second contact surface (9140),
wherein the first abutting ring (9133) and the second abutting ring (9142) can be moved with respect to each other in a coding position of the coded body (9100) and are fixed with respect to each other in a locking position of the coded body (9100).

10. The safety device (1000, 3000, 4000, 5000, 6000, 11000, 12000, 13000, 14000, 15000, 17000) according to claim 9,
wherein the coded body (9100) comprises a plurality of locking rings (9191, 9192, 9193) between which the first abutting ring (9133) and the second abutting ring (9142) are positioned,
wherein the coded body (9100) comprises a supporting element (9194) on which the first abutting ring (9133), the second abutting ring (9142) and the plurality of locking rings (9191, 9192, 9193) are assembled.

11. A safety device (14000, 17000, 18000) designed to cover an element or hole (S) to be placed in a safe condition, the safety device comprising:
a safety cover (14400, 17400),
a first locking element (1200, 6200, 7200, 8200, 14200) and a second locking element (1300, 6200, 7200, 8300, 14300) positioned between the safety cover (14400) and the element or hole (S) to be placed in a safe condition,
wherein the safety cover (14400, 17400) comprises a first contact surface (1130, 9130) and a second contact surface (1140, 9140),
wherein the first locking element (1200, 6200, 7200, 8200, 14200) comprises a first abutting element (1220, 6220, 7220, 8220, 14220, 17220) configured so that it abuts the first contact surface (1130, 9130),
wherein the second locking element (1300, 6200, 7200, 8300, 14300) comprises a second abutting element (1320, 6220, 7220, 8320, 14320, 17320) configured so that it abuts the second contact surface (1140, 9140), and
wherein the first contact surface (1130, 9130) is not coplanar with the second contact surface (1140, 9140)
characterized in that
the safety cover (14400, 17400) comprises a coding cavity (1160) inside which the first abutting element (1220, 6220, 7220, 8220, 14220, 17220) and the second abutting element (1320, 6220, 7220, 8320, 14320, 17320) can be at least partially positioned, and in that
the safety cover (14400, 17400) comprises a release cavity (14170) connected
with the coding cavity (1160), through which the first abutting element (1220, 6220, 7220, 8220, 14220, 17220) and/or the second abutting element (1320, 6220, 7220, 8320, 14320, 17320) can pass.

12. The safety device (17000) according to claim 11, comprising:
at least one first sealing ring (17230, 17233) and one second sealing ring (17231, 17234),
wherein the first sealing ring (17230, 17233) comprises an oblique surface (17235),
and wherein the second sealing ring (17231, 17234) comprises a surface (17236) whose shape is at least partially complementary to the shape of the abutting element (17220).

13. The safety device (17000) according to claim 12, comprising:
a thrust ring (17250) suited to thrust the first sealing ring (17230, 17233) and the second sealing ring (17231, 17234).

14. The safety device (18000) according to claim 11, comprising:
at least one first sealing ring (18230, 18232) and one second sealing ring (18231, 18233),
at least one first thrust element (18250, 18251),
wherein the first thrust element (18250, 18251) is configured in such a way that it thrusts the second sealing ring (18231, 18233) towards the first sealing ring (18230, 18232).
